(19) United States
(12) Patent Application Publication
(10) Pub. No.: US 2026/0257105 A1
(43) Pub. Date: Sep. 3, 2026

(54) TRAJECTORY MEASUREMENT DEVICE, SYSTEM, AND A METHOD THEREOF

(71) Applicant: GameProofer Oy, Kerava (FI)

(72) Inventors: Toni HAKALA, Tampere (FI); Jarno LANKINEN, Tampere (FI); Jukka SJÖSTEDT, Tampere (FI); Juha LILJA, Tampere (FI)

(73) Assignee: GameProofer Oy, Kerava (FI)

(21) Appl. No.: 18/993,782

(22) PCT Filed: Jun. 16, 2023
(86) PCT No.: PCT/FI2023/050358

§ 371 Date: Jan. 13, 2025

(30) Foreign Application Priority Data
Jul. 14, 2022 (FI) 20225671

(51) Int. Cl. A63B 24/00; A63B 71/06

(52) U.S. Cl. CPC A63B 24/0021; A63B 71/0622; A63B 2024/0034; A63B 2220/12; A63B 2220/40; A63B 2220/62; A63B 2220/76; A63B 2225/20; A63B 2225/50

(57) ABSTRACT

The invention relates to tracking the sensor outputs of at least a gyroscope and an accelerometer of a trajectory metering device of the recreational equipment during an activity cycle, for forming a discretized trajectory of a flight path of the equipment. Sensor outputs are transformed into state parameters related to the trajectory presenting at least an initiating period a flight period, and a transition event between the two periods, and associating at least a motional parameter with at least one of the state parameters and sharing the state parameters via a configurable wireless interface for at least partial reconstruction of the trajectory.

### TECHNICAL FIELD

The present invention relates to trajectory measurement systems of gaming objects, wherein the gaming objects being subjected to a projectile motion during sports activities. The invention also relates to a measurement device that may be integrated with an equipment subjected to a flight path.

Moreover, the present invention relates to a method for trajectory tracking of a recreational equipment, a trajectory measurement device for performing the activities, and a carrying case for storing multiple recreational equipment comprising a trajectory measurement device.

### BACKGROUND

Accurate and real-time measurement of various flight properties of a gaming object during a gaming activity is a challenging task. Various ways of tracking the movement of a gaming object for coaching purposes may be based on video surveillance. However, by observing the projectile motion using such external methods does not much differentiate from using an experienced coach practiced in the field. The observations based on an external observation lack all the motional parameters related both to the actual flight path and the moment of departure i.e. when the object is given an impulse in the beginning of the flight path and releases from a subject of the force affected to the object. Such a moment of departure may be, for example, when the object releases from a person's hand or from a stick which is used to affect the movement of the object.

Furthermore, the development activities of frisbee manufacturers have been a matter of trial and error due to the lack of proper measurement of the actual flight properties of various frisbees.

Attempts have been made to attach accelerometers on commercial frisbee units to characterize the dynamic properties of the frisbee during the flight. An obvious solution has been to use one or three accelerometers to measure the rotational movement of the object. However, these approaches have been unable to provide a solution to accurately characterize the various phases of the flight path with a low-power device and in real-time during the actual gaming event. Data logging during an activity, and data analysis afterwards does not fit into fast paced sports activity, and especially when gaming statistics are meant to be shared to a larger audience. Hence, a need for an accurate real-time system becomes evident.

Moreover, the current consumption of known approaches has been a dominant factor in reducing the usability in real-time gaming surveillance. The current consumption may typically be reduced by selecting components of low current consumption, such as in the device according to the present invention, but also in ways of how the system is handing data. An old approach has been to re-direct all sensor data, for example, from an accelerometer directly to an external server for external data processing. However, this has an obvious drawback of draining the battery of the measurement arrangement. And, as is the case in the field of the current invention, the measurement device has to be small in order not to deteriorate the flight characteristics of the flying object itself. This, on the hand, constricts the size of the usable battery, and hence leads to fast battery drainage if attempted to be used in a real-time activity.

In some of the examples provided in this specification, a frisbee equipment and frisbee golf are being used as illustrative examples. However, as it is obvious to anyone skilled in the art, the present invention is not limited to such illustrative examples, but may be utilized in various gaming or recreational fields as well.

### SUMMARY

It is an aim of the present invention to improve the state of the art and to provide a lightweight device, system and method thereof, for real-time characterization of a flight path of an object, such as a recreational equipment, with advanced detection of different phases of said path by said device.

To put it more precisely, the method according to the present invention is primarily characterized in
tracking the sensor outputs of at least a gyroscope and an accelerometer of the trajectory metering device of the recreational equipment during an activity cycle, for forming a discretized trajectory of a flight path of said equipment;
by means of data compression within said device, transforming said sensor outputs into state parameters related to said trajectory, presenting at least an initiating period, a flight period, and a transition event between said two periods, and associating at least a motional parameter with at least one of said state parameters and sharing said state parameters via a configurable wireless interface for at least partial reconstruction of said trajectory;
wherein, prior to said activity cycle, signaling an initiating flag to activate spatial mapping of said device by detecting motional anomalies of said device during a null period of said device, and preparing to detect activity events of said activity cycle;
wherein, during said activity cycle, detecting said activity cycle by said data compression means by:
detecting an initiating period of said trajectory during which the momentum of said equipment being increased by an external force applied to said equipment, and
detecting a flight period of said trajectory during which the momentum of said equipment being decreased in the absence of said force;
wherein, in detecting said periods:
first detecting said flight period from the outputs of said gyroscope by detecting a first gyroscopic component exceeding a first rotational threshold over a first threshold period, and
detecting said initiating period by detecting the transition between said two periods from a null or a local minimum of one of the coordinate components of said tracked accelerometer outputs using a time window exceeding said first threshold period backwards in time after said first gyroscopic component exceeds said first rotational threshold over said first threshold period.

To put it more precisely, the device according to the present invention is primarily characterized in that, said device comprises:
a battery,
a magnetic interface arranged for wirelessly charging said battery via a charging unit,
an antenna arranged to connect said device with members of a trajectory measurement system via a configurable wireless interface operable via said antenna and by a resonant current at least partially coiling in a plane that is crossing the main rotation axis of the equipment upon use of the wireless interface by said device, and wherein the diagonal length of the device being delimited below a quarter of a wavelength at the frequency of operation of said wireless interface,
sensors providing sensor outputs, said sensors comprising at least:
magnetometer
inertial measurement unit comprising at least a gyroscope and an accelerometer,
barometer,
GNSS receiver, and
data compression means arranged to transform the sensor outputs of at least two of the sensors of said device into a state parameter of the recreational equipment related to said device with an associated motional parameter.

To put it more precisely, the carrying case according to the present invention is primarily characterized in that said carrying case comprises:
a plurality of counter interfaces arranged to interact with the magnetic interfaces of said multiple recreational equipment, arranged to charge the batteries of the devices of said multiple recreational equipment stored in said carrying case.

Some advantageous embodiments of the invention are presented in the dependent claims.

In accordance with an embodiment, the device is a measurement device that is adapted to be integrated with a recreational equipment for characterizing the flight properties of the recreational equipment. The device comprises an antenna for providing a configurable wireless interface as a part of a system that is adapted to interact with the measurement device via said interface. The device further comprises a magnetic interface for wireless charging of the battery of the device, and various sensors to measure the motional parameters of the recreational equipment which may be pre-processed prior data transmit via the wireless interface.

The present invention shows some advantages over the solutions of prior art. In an aspect according to the present invention, the device is adapted to detect various phases of an activity cycle of the recreational equipment, comprising at least an initiating period when a gamer is preparing to project an impulse on the recreational equipment, a transition event comprising a moment of an impulse being projected on the equipment when released by the gamer, a flight period with an ascending phase, a levelling phase, and a descending phase. In addition, the invention may be adapted to detect the event of a second impulse at the end of the flight period, followed by a movement stopping period (e.g. a rolling period). The above mentioned activity cycle may be used for active utilization of the various sensors of the device, and the sensors may be set to a sleep mode for a null period preceding the initiating period, and woken up in the event of detected initiating period. Furthermore, an ending sequence after the movement stopping period may be used to dump buffered trajectory data via the configurable wireless interface.

The trajectory measurement device according to the present invention may be characterized as an advanced calculation and sensor data processing unit, that is adapted to enhance the responsiveness and real-time tracking capabilities of an external event surveillance system by refining some of the sensor outputs on-the-fly, and within the moving object itself, and hence sharing refined output to be utilized by external nodes.

The trajectory measurement device according to the present invention may be used to collect a series of trajectory data for a series of varying gaming objects, and by means of detecting various flight phases with assigned motional parameters, the data may be collected for a supervised computerized model via the configurable wireless interface. The trajectory measurement device may also be configured to provide statistics information of various flight paths related to a given user profile or a given gaming object profile. Said statistics information may further be utilized by the system that is adapted to interact with the device for various purposes. As a non-exclusive example, the statistics information may be viewed to an audience using graphical means.

In one aspect, the supervised computerized model may be a form of artificial intelligence.

In one aspect, the supervised computerized model may be arranged to learn non-linear relationships between the measured on-flight parameters of the recreational equipment and the motional parameters of the impulse-like force projected on the recreational equipment at the transition event. Said relationships may be used to teach the critical aspects in an aim to adjust the flight path related to a given sporting equipment, or a gamer profile, or a combination of these, in a given goal.

In another aspect, the supervised computerized model may be arranged to suggest guiding principles on a variable for adjusting the flight performance of a sporting equipment, based on the non-linear relationships learnt by the supervised computerized model. In an advantageous aspect, the computerized model may be taught with labelled inputs of selected trajectory information.

The interface of the supervised computerized model may be implemented in various ways. As a non-exclusive example, an application running on a mobile device, a portable device, or a wearable device, may be used to project the guiding principles on a user or a gamer.

The trajectory measurement device according to the present invention may further comprise advanced means for identifying different phases of the flight path of said device, and optionally trigger activities depending on said phases. The trajectory metering device may be adapted to detect a precise moment when an external impulse is projected on the recreational equipment by first detecting an active flight event using rotational components of a gyroscope axis that cross the main rotation axis of the recreational equipment, and by triggering a traceback search of an accelerometer output data from an event of detecting the flight event for detecting a precise moment of said impulse being projected. Furthermore, the device may also be adapted to assign the departure velocity, departure angle, departure spin, departure tilt angle, and departure nose angle related to the event of said impulse on the trajectory parameters of said equipment.

In an advantageous aspect, the trajectory metering device comprises data compression means to reduce the amount of wirelessly transmitted data frames related to the characterisation of the flight path. The data compression means may be used to conditionally parametrize the digitized trajectory of the flight path by means of identifying various flight phases, suppressing a bit volume provided by sensor outputs of the device, and to provide state information of the phases of the trajectory with associated motional parameters derived from various sensor outputs.

In another aspect of the device, the trajectory metering device may comprise an advanced antenna that is adapted for maximizing the coverage with minimal current consumption. In an aspect of the invention, the antenna may be a low-gain antenna that is arranged to provide a radiation pattern null towards a main rotation axis of the recreational equipment, wherein the antenna is arranged to yield a resonant current at least partially coiling in a plane that is crossing the main rotation axis of the equipment upon use of the wireless interface by said device, and wherein the combined resonator ground plane arrangement being limited to less than a quarter of a wavelength at the frequency of operation of the wireless interface.

In another aspect of the device, there may be various sleep modes being used to inactivate the used of selected sensors when not in use. As a non-exclusive example, the device may toggle a sleep mode of a GNSS receiver outside of an activity cycle. In another non-exclusive example, the device may be configured to toggle on a beacon mode for broadcasting the GNSS location of the equipment after a completed activity cycle, or when a connection to a wireless receiving node is not detected. The device may also be configured to transmit pre-defined set of motional parameters when a connection to a receiving node is not detected, and to toggle on a data exchange mode when a query is detected from an external receiving node. The GNSS receiver may be any satellite based position receiver adapted to receive a variety of different constellations. As a non-exclusive example, the constellation may be GPS. In another non-exclusive example, the constellation may be Galileo, Beidou, Glonass, or the like.

The device according to the present invention may also comprise an advanced charging arrangement for a plurality of trajectory measurement devices. In one aspect, there is provided a carrying case or a carrying bag comprising holders for multiple frisbees with associated wireless chargers adapted to charge the batteries of the measurement devices of the frisbees.

A typical application area for the present invention may be, for example, a field of frisbee golf or the like. The present invention may also be utilized in the development activities of a variety of various gaming objects by means of substantially accurately characterizing the flying aspects of said objects, and enabling the characterization of cross-correlation or the non-linear dependencies between the motional parameters related to the moment of departure, and the flight properties of various phases during the flight path of said gaming objects.

Further, the present invention may be used to collect data relating to the flight properties of various gaming objects, and by means of identifying the non-linear relationships between various motional aspects, the present invention may be utilized to provide coaching information for a gamer in order to enhance the sporting performance.

In this specification, the monitored object may be called a recreational object, a recreational equipment, or simply an object. Some examples of such objects are a frisbee, a golf ball, a tennis ball, a football, a hockey disk etc. What is common to such objects is that they do not have any power source for the movement but all energy required for the movement is caused by an external source before the object starts its free movement. Of course it is clear that external forces such as wind, may affect the actual trajectory of the movement of the object. The power source of the measurement device attached with the object is solely for the operation of the measurement device and not for causing any forces towards the object.

### BRIEF DESCRIPTION OF THE DRAWINGS

In the following, the present invention will be described in more detail with reference to the appended drawings, in which

FIG. 1 shows an abstraction of a device of the invention, in accordance with an embodiment;

FIG. 2 illustrates an example of a flight trajectory and a corresponding time span, in accordance with an embodiment;

FIG. 3 illustrates another example of a plurality of flight trajectories and several determination points, in accordance with an embodiment;

FIG. 4 shows a principle of mutual operations between the objects and the carrying case, in accordance with an embodiment; and

FIG. 5 shows a simplified block diagram of a trajectory measurement device, in accordance with an embodiment.

### DETAILED DESCRIPTION

Trajectory tracking of gaming objects may be used to provide statistics information for the gamers as well as for the viewers of the game in various recreational activities. In addition, accurate flight track characterization may be used to learn various aspects related to the gamer performance, and more importantly, on the performance of the gaming object itself. This is a field where various parameters related to the flight properties of the gaming object, and their mutual relationships, may only be characterized by accurate enough measurements of the dynamics of the object itself during the activity cycles of the game.

Moreover, by learning the non-linear relationships between the dynamic parameters of the gaming object at the event when e.g. a gamer throws a frisbee, and the dynamic parameters associated with various phases of the flight track of the frisbee, guiding principles, such as “increase spin or try another frisbee type”, may be determined to enhance the performance of the gamer. Such guiding principles may be effectively determined using a supervised computerized model, that is provided with a series of measured trajectory data associated with specific types of frisbees or other recreational equipment. A gamer or an external feedback may be used to guide the learning process of the supervised computerized model.

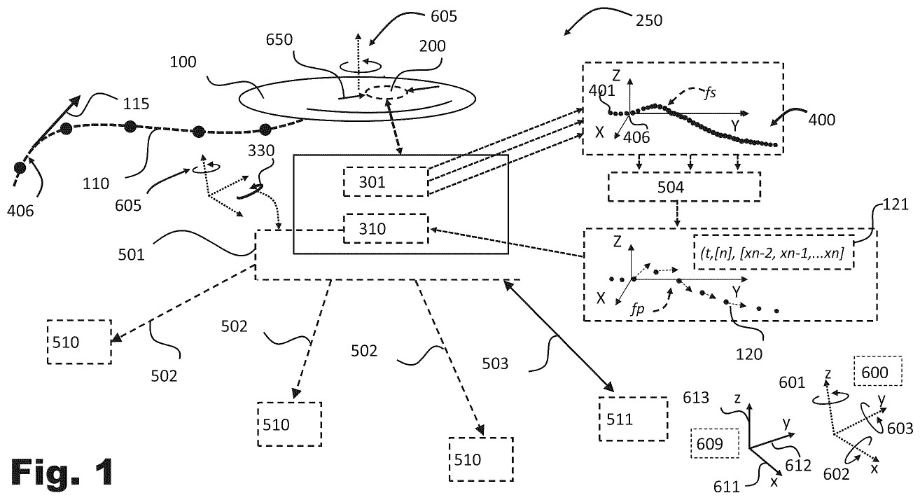

FIG. 1 shows an abstraction of a device 200 of the invention, in accordance with an embodiment. The object 100 is travelling a flight path 110 (a.k.a. a flight trajectory) which is measured by a positioning device such as a GNSS receiver 305 of the trajectory measurement device 200. In addition to or instead of the GNSS receiver 305 the flight path may be measured by one or more other sensors of the device 200. As an example of such sensors, an accelerometer 304, a magnetometer 303 and/or an inertial measurement unit 320 may be used. A barometer 306 may be used to detect changes in the altitude of the object.

The sensor data may be stored into a memory 311 of the device 200 and analyzed by the control unit 312. Alternatively or additionally, the sensor data 301 may be broadcast 502 by a digital radio transceiver 310 of the device and received by one or more receiving nodes 510 during the flight. The received data may then be analyzed by the receiving nodes 510 or forwarded to a separate device (not shown) for data analyses.

There may also be data exchange channel 503 for data exchange.

Prior to transmission a data compressor 504 may compress the sensor data and possible other data so that the amount of data to be transmitted can be reduced, wherein the transmission can be performed faster. Less data to be transmitted may also reduce power consumption of the device, because the transceiver 310 may be switched off when there is not data waiting for transmission.

FIG. 1 also illustrates a main rotation axis 605 of the object, accelerometer coordinates 609 comprising a first accelerometer coordinate output 611, a second accelerometer coordinate output 612 and a third accelerometer coordinate output 613. The accelerometer 304 is attached to the device so that its position with respect to the object 100 is as stable as possible and the positional relationship between the accelerometer 304 and the device 100 is known, or may be determined. It is assumed in this specification that the position of the accelerometer 304 with respect to the object 100 does not change during the activity cycle, wherein changes in any of the first, second and third accelerometer coordinate output indicate a change in the position of the object 100.

FIG. 1 further illustrates gyroscopic coordinates 600 comprising a first gyroscopic component output 601, a second gyroscopic component output 602 and a third gyroscopic component output 603. Also the gyroscope 302 is attached to the device so that its position with respect to the object 100 is as stable as possible and the positional relationship between the gyroscope 302 and the device 100 is known. It is assumed in this specification that the position of the gyroscope 302 with respect to the object 100 does not change wherein changes in any of the first, second and third gyroscopic component output indicate a change in the position of the object 100.

The reference numeral 120 in FIG. 1 illustrates an example of a digital representation of a measured flight path 110. The reference numeral 121 in FIG. 1 illustrates state parameters obtained during and/or after the flight from the sensor data 301.

The graph 400 illustrates an activity cycle comprising a full movement of the object 100. Before the object is released there is a null cycle when the object is not played (thrown, hit, etc.). Reference numeral 406 illustrate transitions (events) between two different periods.

When the object 100 is thrown and detached from a hand of the player, the direction of the object 100 can be represented with a departure vector 115. This is determined by one or more of the sensors of the device 100.

It should be noted that when this disclosure mentions that changes in the location, speed, position, etc. of the object is sensed/detected, it is actually based on sensor output of the device 200 but as it was mentioned above, the relational position of the sensors and the object is preferably fixed wherein the sensor data is in correspondence with the movement and position of the object.

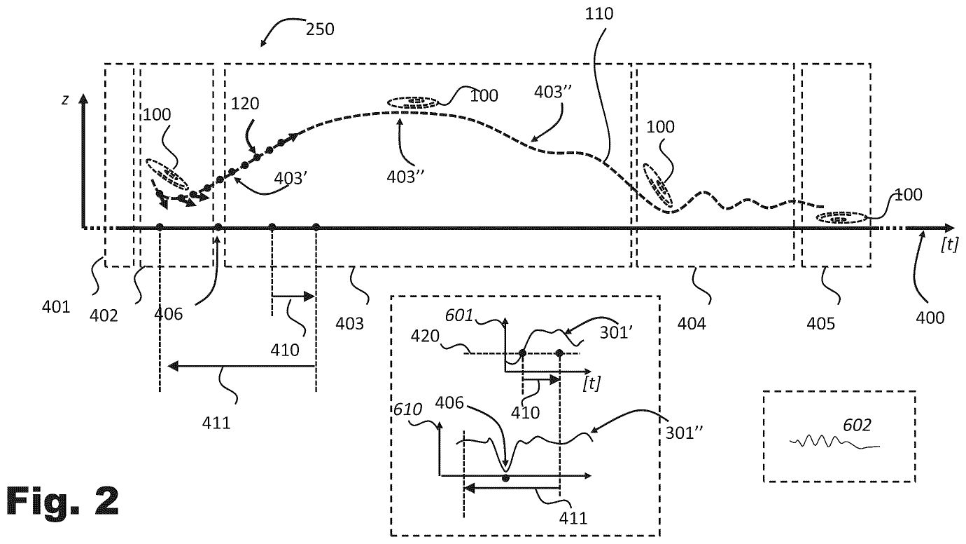

FIG. 2 illustrates an example of a flight trajectory 110 of the object 100 and a corresponding time span (activity cycles 400), in accordance with an embodiment. Now, the activity cycles presented in FIG. 2 will be explained. The operation starts with a null cycle 401, when the object is not yet thrown, but may not even be picked up by a player. The sensor data 301 may indicate no motion, or weak movement that is not relating to the activity cycle. At the initiation period 402 the object 100 is picked up by the player and the player begins to prepare a throw. Now there is some activity in the sensor data 301 which may be detected and deduced that the object 100 is at a state prepared for throwing and sensor data from that point may be analyzed. It should be noted again that the analyses may or may not be real-time but is performed afterwards. For this disclosure, it does not have any difference with respect to the analyses because the data to be analyzed is the same. The arrow 411 illustrates an example of a time window in which the event where the object leaves a hand of the player will be determined. Such determination may need sensor data from multiple sensors and be compared with a predetermined pattern to find out when the object left the hand and the free-flight started. The data gathered during the flight may also reveal when the object were rising higher i.e. was at an ascending phase 403′, when the object was flying at a substantially constant height i.e. was at a levelling phase 403″, when the object was flying downwards i.e. was at a descending phase 403′″, and when the object 100 touched the ground and possibly continued its movement by rolling, bouncing etc. i.e. was at a movement stopping phase 400. When the movement of the object 100 has been stopped i.e. at the end sequence 405, it may be deduced that the flight has ended and the data is ready for analyses, broadcasting etc. unless the data was already analysed and/or broadcast during the flight.

At the beginning of the flight, a speed vector usually points upwards and/or shows a swaying kind of movement. These are indicative of the ascending phase 403′. The levelling phase 403″ may be detected when the speed vector changes its direction to more or less horizontal direction and/or acceleration in the z-direction becomes zero or almost zero. The descending phase 403″ may be detected based on, for example, increasing negative acceleration in the z-direction and/or when the direction vector starts to point downwards.

FIG. 2 illustrates some further details of examples of sensor data, which are now explained. The graph 602 illustrates an output of a second gyroscopic component during the rolling phase. Graph 602 may also illustrate an output of a third gyroscopic component 603 during the rolling phase The graph 601 illustrates an output of a first gyroscopic component which corresponds with the main rotation axis during flight (not start of flight).

A release moment i.e. when the object leaves the hand of the player may be detected when there is an abrupt change in sensor data within the time window 411. In the example of FIG. 2 the sensor data shows a deep drop between different moments, wherein the controller may determine that this moment represents the release moment. In accordance with an embodiment, the device 200 is adapted to detect the release moment in a reversely recursive manner, wherein an event during the flight period 403 triggers a backwards search of the release moment that started the flight period 403.

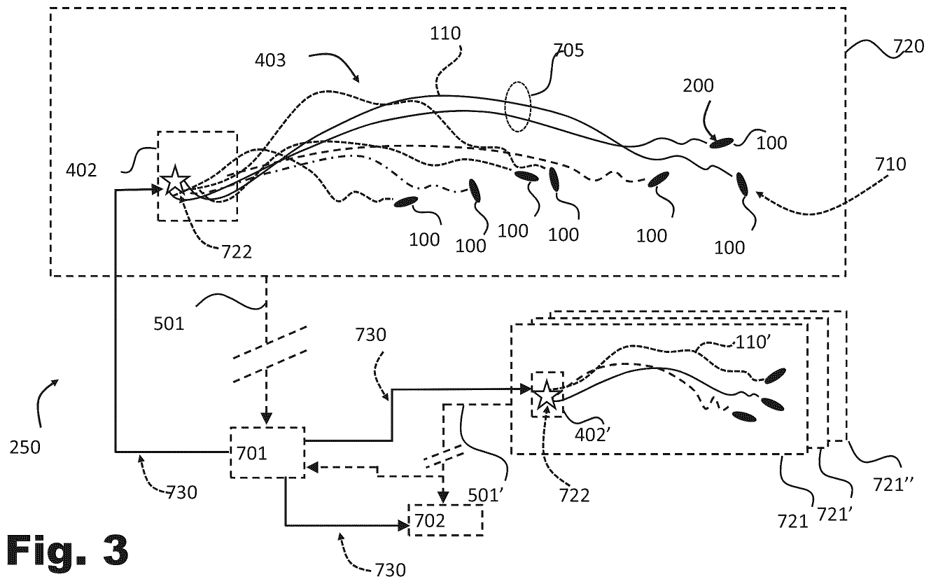

FIG. 3 illustrates an example of a plurality of flight trajectories and several determination points, in accordance with an embodiment. The player is indicated with the reference numeral 722, and measured trajectories of several throws (i.e. series of activity cycles during data collection) are illustrated with graphs 110 inside the rectangle 720.

FIG. 3 also illustrates that the trajectory measurement system 250 may collect trajectory data from several gaming/rehearsal sessions 721, 721′, 721″, wherein the data may be used to analyse possible details how to improve the performance of the player 722. This may be performed by a supervised computerized model 701 which is provided data via a configurable wireless interface 501, for example. The supervised computerized model 701 may prepare guiding principles 730 and provide them to the player 722 and/or to a variable-specific supervised computerized profile 702. In that way, a learning procedure may be used to improve the accuracy and quality of the variable-specific supervised computerized profile 702.

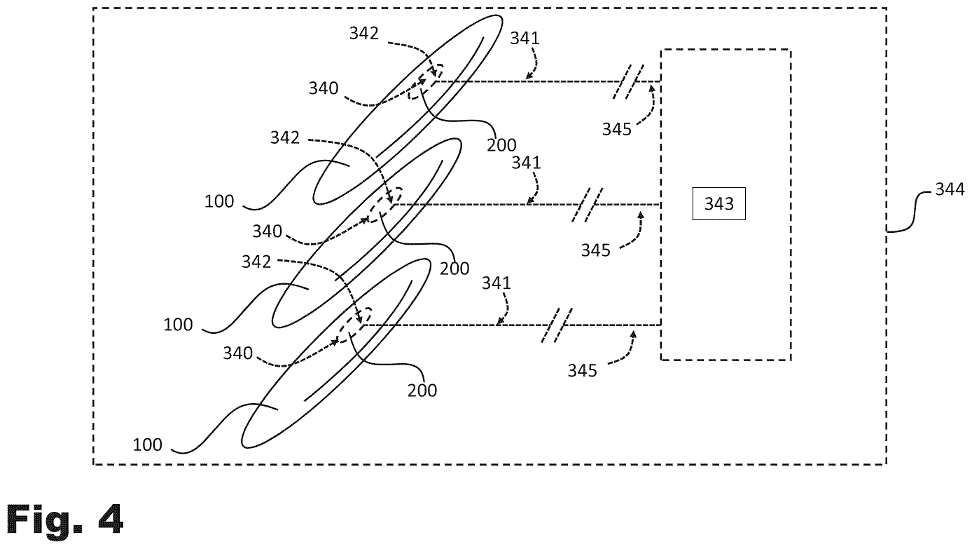

FIG. 4 shows a principle of mutual operations between the objects and a carrying case 344, in accordance with an embodiment. The carrying case 344 may comprise a charger unit 343 which can be used to charge the battery 340 of the devices 200 of the objects 100 when the objects 100 are in the carrying case 344. The charging may happen wirelessly, for example by using a magnetic interface 341 of the devices 200 and a counter interface 345 of the charger unit 343. Said carrying case 344 is a portable case that comprises an power storage adapted to be used for charging the batteries of the devices 200 via said magnetic interfaces.

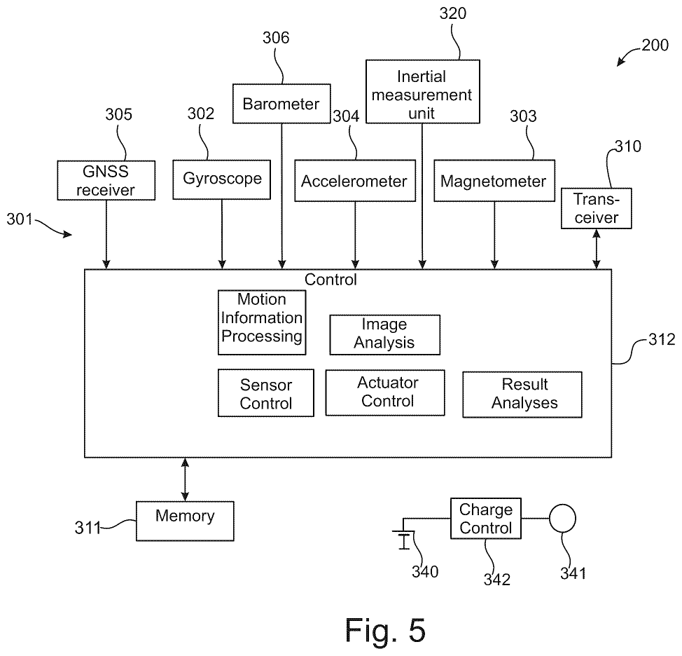

FIG. 5 shows a simplified block diagram of a trajectory measurement device 200, in accordance with an embodiment. The device comprises the gyroscope 302, the magnetometer 303, the accelerometer 304, the GNSS receiver 305, the barometer 306, the digital radio transceiver 310, the memory 311, the control unit 312, the inertial measurement unit (IMU) 320, at least partially coiling resonant current 330, the battery 340, the magnetic interface 341, and the charging unit 342.

It should be noted, however, that some of the sensors may not be in all implementations. It is also possible that the device 200 may comprise other elements not mentioned in this specification.

In the following, some further details are provided.

In the scope of this specification, the flight path 110 is referred to as the analog path that the recreational equipment 100, i.e. an object with mass in motion follows through a three-dimensional space as a function of time.

In the scope of this specification, the trajectory 120 is referred to as the digital representation of the flight path 110, wherein the digital representation may be any of a time sequenced or spatially mapped sensor data, or a model based parameterized data. In an embodiment, said model may be any of a causal, deterministic, or a statistical model.

In an advantageous embodiment, said trajectory 120 is a collection of discrete measurement data samples in a digital memory device, wherein said collection comprises an ordered sequence of data points of at least two different quantities stored and mapped for an identifiable trajectory 120 in such arrangement, that said at least two quantities are mutually mapped, and said mapping defines at least partly a discretized model of said flight path 110.

In an embodiment, at least one of said quantities comprises a discrete series of time samples.

In an embodiment, at least one of said quantities comprises a discrete series of at least one of the gyroscope 302, the magnetometer 303, the accelerometer 304, the GNSS receiver 305, or the barometer 306.

When the recreational equipment 100 of the current invention is subjected under an externally applied force, i.e. external force is projected on the equipment 100, the momentum of the equipment increases. In the event of applying said force, the object with mass, which in this specification refers to the recreational equipment 100, experiences acceleration in a direction defined by a spatial vector. This event is referred to as an initiating period 402. In an advantageous embodiment, the initiating period 402 is an event of throwing the recreational equipment 100, and when the recreational equipment 100 is in interaction with an external body that is projecting the external force on the equipment 100.

In another embodiment, the initiating period 402 is an event of subjecting the recreational equipment 100 under an impulse by an external body.

In an embodiment, the initiating period 402 is an event of throwing a frisbee.

In an alternative embodiment, the initiating period 402 is an event of shooting an arrow with a bow, wherein said arrow is the recreational equipment 100.

In an event of transition 406, the initiating period 402 ends and the recreational equipment 100 becomes a passenger traveling along the flight path 110. At said event, the momentum of the recreational equipment 100 either remains constant, or starts to degrade due to the energy lost in interactions between said equipment and the surrounding media. The surrounding media may be in gaseous form, gas such as air, or it may be a liquid, such as water or the like. The surrounding media may be stationary, or it may be subjected to fluid motion. The interactions may be due to wind or air resistance of a homogeneous or non-homogeneous gaseous air.

In an embodiment, the device 200 is adapted to determine the transition event 406 within 10 ms time window, based on an anomaly detection from the gyroscope 302 outputs, followed by event 406 determination from accelerometer 304 outputs.

When the recreational equipment 100 travels along the flight path 110, various motional parameters may be recorded.

In an embodiment, the force interacting with the recreational equipment 100 during the initiating period 402 may be a rotational force, wherein the direction of said trajectory is defined by the tangent of the rotation direction. Said tangent of the rotation direction is defined at the event of the transition 406 between the initiating period 402 and the flight period 403.

Applied external force may be applied to the recreational equipment 110 along or via an external body.

In an embodiment, said force is applied with a limb of a person interacting with said recreational equipment 110.

The trajectory measurement device 200 according to the present invention may be used to collect a series of trajectory data for a series of varying gaming objects, and by means of detecting various flight phases with assigned motional parameters, the data may be collected for a supervised computerized model 701 via the configurable wireless interface 501. The trajectory measurement device 200 may also be configured to provide statistics information of various flight paths related to a given user profile or a given gaming object profile. Said statistics information may further be utilized by the system that is adapted to interact with the device for various purposes. As a non-exclusive example, the statistics information may be viewed to an audience using graphical means.

In an embodiment, the trajectory measurement device 200 comprises a battery 340, a magnetic interface 341 arranged for wirelessly charging said battery 340 via a charging unit 342, an antenna arranged to connect said device 200 with members of a trajectory measurement system 250 via a configurable wireless interface 501 operable via said antenna and by a resonant current 330 at least partially coiling in a plane that is crossing the main rotation axis 605 of the equipment upon use of the wireless interface 501 by said device 200, and wherein the diagonal length 650 of the device 200 being delimited below a quarter of a wavelength at the frequency of operation of said wireless interface 501, and sensors providing sensor outputs, said sensors comprising at least a magnetometer 303, inertial measurement unit 320 comprising at least gyroscope 302 and accelerometer 304, barometer, GNSS receiver, and data compression means 504 arranged to transform the sensor outputs 301 of at least two of the sensors of said device into a state parameter 121 of the recreational equipment related to said device 200 with an associated motional parameter. In addition, said device 200 may comprise temperature sensor. Said temperature sensor may be adapted to be used to study the dependencies of various flight parameters on air temperatures.

In an embodiment, the device 200 for tracking a state of a recreational equipment 100 is characterized in that, the device being a trajectory metering device 200 of said recreational equipment 100 comprising at least a gyroscope 302, and a magnetometer 303, and at least one of an accelerometer 304, a GNSS receiver 305, or a barometer 306, and; said device 200 comprising a digital radio transceiver 310 with a configurable waveform for exchanging data via a configurable wireless interface 501, and; said device 200 being adapted to track the state of said recreational equipment 100 during an activity cycle 400 of said equipment 100 with said device 200 comprising means to detect an initiated activity cycle 400 during a flight period 403, comprising at least means for detecting a rotational anomaly in the main rotational axis of said recreational equipment 100 by means of mapping two gyroscopic components of the two axes crossing the axis of said main rotational axis for the detection of said flight period 403, and; said device 200 being configured to share said state via said interface 501.

In one aspect, the supervised computerized model 701 may be arranged to learn the non-linear relationships between the measured on-flight parameters of the recreational equipment 100 and the motional parameters of the impulse-like force projected on the recreational equipment at the transition event. Said relationships may be used to teach the critical aspects in an aim to adjust the flight path related to a given sporting equipment, or a gamer profile 702, or a combination of these, in a given goal.

In another aspect, the supervised computerized model 701 may be arranged to suggest guiding principles 730 on a variable for adjusting the flight performance of the recreational equipment 100, based on the non-linear relationships learnt by the supervised computerized model 701. In an advantageous aspect, the computerized model 701 may be taught with labelled inputs of selected trajectory information.

In a non-exclusive example, such labelled input may be provided by the gamer, using a mobile application or the like, to provide labelling feedback. Such feedback may be provided, e.g. by using a “thumb up” and “thumb down” for various activity cycles. Moreover, exceptionally good cycles may be labelled with a “star” or other means with higher weight coefficient.

In a non-exclusive example, the labelled inputs may be also be provided by the manufacturers of various types of recreational equipment in a form of typical or ideal flight paths of a given recreational equipment 100.

In a non-exclusive example, the trajectory data may be also be provided by the manufacturers of various types of recreational equipment in a form of typical or ideal flight paths of a given recreational equipment 100.

The interface of the supervised computerized model, may be implemented in various ways. As a non-exclusive example, an application running on a mobile device, a portable device, or a wearable device, may be used to project the guiding principles on a user or a gamer.

The non-linear relationships between the dynamic parameters of the recreational equipment 100 (e.g. a gaming object) at the event when, e.g. a gamer throws a frisbee (referred to as the transition event 406, and the dynamic parameters associated with various phases of the flight track of the frisbee, may be used for to generate the guiding principles 730 for the gamer. The guiding principles 730 may be reflected against a single measured activity cycle 400, or against a gamer profile 702 that is a computerized model of a kind itself, adapted to mimic the characteristics of a single player. Such gamer-specific models 702 may further be used to reflect the development of the gamer over time, when being coached by the supervised computerized model. As a non-exclusive example of embodiments of the invention, the guiding principle 730 may contain any of the following principles, each alone, or arbitrarily combined: guidance to change the recreational equipment 100 to another of which the dynamic properties fit better for the gamer characteristics, guidance to increase spin, guidance to adjust nose angle, guidance to adjust tilt angle, guidance to adjust departure vector 115, guidance to release moment to adjust the transition event 406.

In an alternative embodiment, the supervised computerized model 701 is provided with multiple inputs from a plurality of devices 200 assigned to an activity cycle 400, wherein at least one of said devices 200 is integrated with an external body that is arranged to project external force on said equipment 100.

In an alternative embodiment, the variable-specific supervised computerized profile 702 is provided with multiple inputs from a plurality of devices 200 assigned to an activity cycle 400, wherein at least one of said devices 200 is integrated with an external body that is arranged to project external force on said equipment 100.

In the above arrangements, the external body may be any wearable equipment, club, racket, stick, mallet, paddle, or racquet, wherein said at least one of said devices 200 being arranged to measure the dynamics of said body during the initiating period.

In an embodiment, there is provided a method for characterizing flight properties of the recreational equipment 100, wherein said method being characterized in, identifying at least one recreational equipment 100 as a first set of variables; collecting trajectory 120 parameters for a series 720 of activity cycles 400 related to each identified member 710 of said first set of variables via a configurable wireless interface 501 of a trajectory measurement system 250; wherein: using a trajectory metering device 200 associated with each identified member 710 of said first set of variables for providing state information with related trajectory 120 parameters of said variables, derived from the sensor outputs 301 of said device 200 by said device 200; via said configurable wireless interface 501 and from said device 200, receiving said state information by: 1) receiving information of a detected flight period 403 having an ascending phase 403′, a leveling phase 403″, and descending phase 403′″, associated at least with motional parameters of spatial velocity, spin, tilt angle, nose angle, and altitude, and; 2) receiving information of a transition event 406 between an initiation period 402 and said flight period 403 detected by said device 200, and receiving said information associated at least with the departure vector 115 comprising departure angle and departure velocity, and other motional parameters at least of departure spin, departure tilt angle, and departure nose angle, and; 3) receiving information of a rolling period 406 tailing said flight period 403, associated at least with geospatial location information and flight time of the associated recreational equipment 100; and providing said trajectory 120 parameters and related state information to be used as a training set for a supervised computerized model 701, wherein said supervised computerized model 701 being adaptable to learn the non-linear dependencies between at least one of the motional parameters of the transition events 406 and at least one of the motional parameters of the flight periods 403 of said series of collected activity cycles 400 identifiable with each member 710 of said first set of variables; wherein: from said series of collected activity cycles 400, providing a set of cycles 400 identifiable as labeled inputs 705 for said supervised computerized model 701, and providing said cycles 400 associable with a corresponding identified member 710 of said first set of variables, and providing said cycles 400 identifiable as labeled inputs to be used by said supervised computerized model 701 to suggest guiding principles based on a new transition event 406 detected with a trajectory metering device 200 of an identifiable recreational equipment 100.

In an embodiment, there is provided a method for tracking the state of the recreational equipment 100 during an activity cycle 400 of said equipment 100, characterized in: providing state information of a detected transition event 406 of a recreational equipment 100 during an activity cycle 400 of said equipment 100 with a trajectory metering device 200 of said recreational equipment 100; providing said state information combined with a motional parameter derived from an event of suppression of at least two time-harmonic components of at least three output components of a gyroscope 302 of said trajectory metering device 200.

In an embodiment, there is provided a method for tracking the state of the recreational equipment 100 during an activity cycle 400 of said equipment 100, characterized in: providing state information of a detected transition event 406 of a recreational equipment 100 during an activity cycle 400 of said equipment 100, wherein; providing said state information derived from gyroscope 302 and accelerometer 304 based trajectory 120 parameters by a trajectory metering device 200 of said recreational equipment 100 by providing said state information by a detection of an anomaly of the accelerometer 304 output within a time window 411 of a buffer traceback search of said accelerometer 304 output triggered by an anomaly of a first 601 gyroscopic 302 component; providing said information via a broadcast channel 502 or a data exchange channel 503 of a configurable wireless interface 501 of a trajectory measurement system 250 to be shared with a receiving node 510 or a data exchange node 511 of said system 250; providing said state information available for at least one of said nodes 510,511 via at least one of said channels 502,503 with at least one motional parameter assigned to said transition event 406 by said device 200.

As a non-exclusive example of embodiments of the invention, the guiding principle 730 may contain any of the following principles, each alone, or arbitrarily combined, when at least one device 200 being integrated with the external body: guidance to adjust release moment with respect to stabilization moment of a fulcrum, guidance to adjust the altitude of the force-projecting member in the end or at the beginning of the initiating period, guidance to adjust body posture with respect to the recreational equipment, guidance to adjust body posture with respect to the force-projecting member.

Trajectory data may be personalized and/or associated with a certain object, wherein the user and/or the object may need to be indicated to the system. On the other hand, each trajectory measurement device 200 may comprise an identifier which may be associated with data transmitted by the device 200. Hence, the system may use the identifier to distinguish between different objects.

In an embodiment, there is provided a supervised computerized model 701 for adjusting the flight performance of a recreational equipment 100 associated with gaming activities, characterized in that, the supervised computerized model 701 being adapted to learn the non-linear dependencies between at least one motional parameter associated with the transition events 406 and at least one of motional parameter associated with the flight periods 403 in series 720 of collected activity cycles 400 of recreational equipment 100, and wherein said series 720 being identifiable with at least one member 710 of a first set of variables of said series 720, wherein, said supervised computerized model 701 being adapted to suggest guiding principles based on a new transition event 406, detected with a trajectory metering device 200 of a recreational equipment 100 identifiable with said at least one member 710, for adjusting the flight performance of said recreational equipment 100.

The supervised computerized model may be a form of artificial intelligence adapted to weight preferred trajectories in the learning process with labeled inputs provided by a gamer on the basis of measured flight paths.

The model 701 may be adapted to distinguish the effects of wind on any of the measured trajectory parameters provided by the device 200.

The model 701 may be adapted to identify the anomalies caused by wind on the average or predicted trajectories and in any of the measured trajectory parameters provided by the device 200.

In an embodiment, the supervised computerized model 701 may be adapted to interact with a supervised computerized profile 702, wherein said profile being adapted to reflect the gamer-specific flight properties of a recreational equipment 100, associated with said at least one identifiable member 710.

In an embodiment, the supervised computerized model 701 may be adapted to suggest guiding principles on said supervised computerized profile 702.

In an embodiment, the supervised computerized model 701 may be adapted to reflect the progress of the supervised computerized profile 702 on the basis of the suggested guiding principles on at least one of the motional parameters associated with said transition event 406.

In an embodiment, the supervised computerized profile 702 may be an avatar that is adapted to reflect statistical parameters of a gamer profile, comprising at least two of a measured departure velocity, departure angle, departure tilt angle, departure nose angle, average altitude during the flight path, average distance of a flight path, and maximum distance of a flight path, associated with said at least one member 710 of said first set of variables.

Said avatar may be adapted to be reflect gamer-specific statistics or gaming behavior in a virtual environment.

In an alternative embodiment, said virtual environment is a computerized game.

In another alternative embodiment, said virtual environment is an environment in a metaverse.

In an alternative embodiment, said supervised computerized profile 702 is adapted to reflect a gamer in form of a virtual gamer card.

In an embodiment, said force is applied with a sports equipment.

In an advantageous embodiment the recreational equipment 100 is a frisbee. In an alternative embodiment, said recreational equipment 100 is an American football.

In another alternative embodiment, said recreational equipment 100 is a soccer ball.

In another alternative embodiment, said recreational equipment 100 is a rugby ball.

In an alternative embodiment, said recreational equipment 100 is a javelin.

In an alternative embodiment, said recreational equipment 100 is a baseball. In an alternative embodiment, said recreational equipment 100 is a bowling ball.

In an alternative embodiment, said recreational equipment 100 is a kite.

In an alternative embodiment, said recreational equipment 100 is a glider.

In an embodiment, said sports equipment is any of an ice hockey stick, a bat, a paddle, a stick, a club, a racket, or a mallet.

In an alternative embodiment, said sports equipment is a bow comprising a string, and the force is applied via said spring.

In an advantageous embodiment, the first threshold period 410 is 50 ms.

In an advantageous embodiment, the first rotational threshold is 5.5 Round Per Second (RPS).

In an advantageous embodiment, the time window 411 for detecting the transition (406) is over 100 ms.

In an alternative embodiment, the time window 411 for detecting the transition 406 is between 50 ms and 10000 ms.

In an embodiment, the spatial mapping of the device 200 comprises at least detecting the outputs of the gyroscope and the accelerometer.

In an alternative embodiment, the spatial mapping of the device 200 comprises at least detecting the outputs of the gyroscope, accelerometer, and the GNSS receiver.

In another alternative embodiment, the spatial mapping of the device 200 comprises at least detecting the output of the GNSS receiver.

In the following some examples will be provided.
1. A method for trajectory tracking of a recreational equipment 100, characterized in:
   tracking the sensor outputs 301 of at least a gyroscope 302 and an accelerometer 304 of a trajectory metering device 200 of the recreational equipment 100 during an activity cycle 400, for forming a discretized trajectory of a flight path 110 of said equipment 100;
      by means 504 of data compression within said trajectory metering device 200, transforming said sensor outputs 301 into state parameters 121 related to said trajectory 120, presenting at least an initiating period 402, a flight period 403, and a transition event 406 between said two periods, and associating at least a motional parameter with at least one of said state parameters 121 and sharing said state parameters 121 via a configurable wireless interface 501 for at least partial reconstruction of said trajectory 120;
      wherein, prior to said activity cycle 400, signaling an initiating flag to activate spatial mapping of said device 200 by detecting motional anomalies of said device 200 during a null period 401 of said trajectory metering device 200, and preparing to detect activity events of said activity cycle (400;
   wherein, during said activity cycle (400, detecting said activity cycle (400 by said data compression means 504 by:
      detecting an initiating period 402 of said trajectory 120 during which the momentum of said equipment 100 being increased by an external force applied to said equipment 100, and
      detecting a flight period 403 of said trajectory 120 during which the momentum of said equipment 100 being decreased in the absence of said force;
      wherein, in detecting said periods:
         first detecting said flight period 403 from the outputs of said gyroscope 302 by detecting a first gyroscopic component 601 exceeding a first rotational threshold 420 over a first threshold period 410, after which;
         detecting said initiating period 402 by detecting the transition 406 between said two periods from a null or a local minimum of one of the coordinate components of said tracked accelerometer 304 outputs using a time window 411 exceeding said first threshold period 410 backwards in time after said first gyroscopic component exceeds said first rotational threshold 420 over said first threshold period 410.
2. The method according to example 1, wherein, by means 504 of data compression within said device 200, using a windowed moving average on at least one of said sensor outputs 301 in generation of said trajectory 120 to be shared via said interface at a compressed rate.
3. The method according to example 1, wherein, by means 504 of data compression within said device 200, using suppressed sample rate on at least one of said sensor outputs 301 in generation of said trajectory 120 to be shared via said interface at a compressed rate.
4. The method according to any of the examples 1-3, wherein, in forming said discretized trajectory 120, using a non-uniform sampling ratio during said activity cycle 400 by using a sampling ratio of at least 2:1 between two activity phases.
5. The method according to any of the examples 1-4, wherein, in detecting said first gyroscopic component 601, prior to detecting said first gyroscopic component 601, using a projection from a second 602 or a third 603 gyroscopic component for generation of said first 601 gyroscopic component to be detected.
6. The method according to any of the examples 1-4, wherein, in detecting said first gyroscopic component 601, prior to detecting said first gyroscopic component 601, using a root of a time-inharmonic cyclometric function for projecting a second 602 or a third 603 gyroscopic component as said first 601 gyroscopic component to be detected.
7. The method according to any of the examples 1-6, wherein, tracking the sensor outputs 301 of at least said gyroscope 302 and said accelerometer 304 using an inertial measurement unit 320 of said device 200.
8. The method according to any of the examples 1-7, wherein, in detecting said periods, said first threshold period 410 being between 1 ms and 5000 ms.
9. The method according to any of the examples 1-8, wherein, in detecting said flight period 403, using a rotational threshold 420 between 1 and 50 RPS.
10. The method according to any of the examples 1-9, wherein,
   after signaling said initiation flag, tracking the outputs of said accelerometer 304, and;
   after detecting said transition 406 event, associating the spatial velocity derived from said accelerometer 304 outputs with said transition event 406, and;
   sharing said state parameters via said configurable wireless interface 501 for at least partial reconstruction of said trajectory 120.
11. The method according to any of the examples 1-10, wherein, using a buffer traceback search triggered by the detection of said transition 406 event for associating said transition 406 event with the related momentary motional parameters of at least spatial velocity, launch angle, spin, and tilt, and sharing said state related motional parameters via said configurable wireless interface 501 to be visualized by a trajectory measurement system 250.
12. The method according to any of the examples 1-11, wherein, in sharing said state parameters 121 via the configurable wireless interface 501, using an antenna with an average gain below +5 dBi and with the diagonal length 650 of the device 200 delimited below a quarter of a wavelength at the frequency of operation of said wireless interface 501 and with a resonant current 330 at least partially coiling in a plane that is crossing the main rotation axis 605 of the equipment upon use of the wireless interface 501 by said device 200.
13. The method according to any of the examples 1-12, wherein, during said flight period 403,
   distinguishing an ascending phase 403′ from a leveling phase 403″, of said equipment 100 by said device 200 by combined data from the gyroscope 302 and an accelerometer 304.
14. The method according to example 13, wherein, during said activity cycle 400,
   distinguishing an ascending phase 403′ from said leveling phase 403″, of said equipment 100 by said device 200 by
   receiving information of a detected flight period 403 having an ascending phase 403′, a leveling phase 403″, and descending phase 403′″, associated at least with motional parameters of spatial velocity, spin, tilt angle, nose angle, and altitude;
   detecting an initiating period 402 of said trajectory 120 during which the momentum of said equipment 100 being increased by an external force applied to said equipment 100, and
   detecting a flight period 403 of said trajectory 120 during which the momentum of said equipment 100 being decreased in the absence of said force;
   wherein, in detecting said periods data from the gyroscope 302 and an accelerometer 304 are used.
15. The method according to any of the examples 1-14, wherein, determining a start event of a rolling period 404 that follows said flight period 403 by detecting the main rotation axis being tilted by detecting said first gyroscopic component 601 falling below said first rotational threshold 420, and detecting the start of an end sequence 405 by detecting the moving average of at least three samples from the output of the GNSS receiver 305 being stabilized inside a radius less than 1.5 meters,
   and;
using the duration of said flight period 403 for the determination of the flight time of said recreational equipment 100, and the duration of said rolling period 404 on the basis of said start of said end sequence 405.
16. The method according to any of the examples 1-15, wherein, using said discretized trajectory 120 for teaching a supervised computerized model 701 to learn the non-linear relationships between at least two parameters associated with dynamics of said recreational equipment 100 tracked by said device 200 during said initiation period 402 and dynamics of said recreational equipment 100 tracked by said device 200 during said flight period 403.
17. The method according to any of the examples 1-15, wherein, using a supervised computerized model 701 for learning the non-linear relationships between at least two parameters associated with the dynamics of said recreational equipment 100 tracked by said device 200 during said initiation period 402 and the dynamics of said recreational equipment 100 tracked by said device 200 during a series 720 of activity cycles associated with said recreational equipment 100, and reflecting said relationships on a variable-29 specific supervised computerized profile 702 taught to mimic the dynamics of a gamer 722 operating said recreational equipment 100 from a series of gaming cycles 721 for generating guiding principles 730 for adjusting the dynamics of said gamer 722 during an initiation period 402.
18. The method according to example 17, wherein, providing said supervised computerized model 701 with wind inputs comprising at least of a direction and an intensity of wind associated with at least two of the activity cycles of said series 720 of activity cycles for said model to learn trajectorial anomalies caused by wind, wherein in providing said wind inputs, providing at least two non-uniform wind inputs associated with a common variable.
19. A trajectory measurement device 200 for performing the activities according to examples 1-18, characterized in that, said device 200 comprises:
   a battery 340,
   a magnetic interface 341 arranged for wirelessly charging said battery 340 via a charging unit 342,
   an antenna arranged to connect said device 200 with members of a trajectory measurement system 250 via a configurable wireless interface 501 operable via said antenna and by a resonant current 330 at least partially coiling in a plane that is crossing the main rotation axis 605 of the equipment upon use of the wireless interface 501 by said device 200, and wherein the diagonal length 650 of the device 200 being delimited below a quarter of a wavelength at the frequency of operation of said wireless interface 501,
sensors providing sensor outputs, said sensors comprising at least:
   magnetometer 303
   inertial measurement unit 320 comprising at least a gyroscope 302 and an accelerometer 304,
   barometer,
   GNSS receiver, and;
data compression means 504 arranged to transform the sensor outputs 301 of at least two of the sensors of said device into a state parameter 121 of the recreational equipment related to said device 200 with an associated motional parameter.
20. A trajectory measurement device 200 according to example 19, characterized in that,
said device 200 being arranged to provide said state parameters 121 and the associated motional parameters via a broadcast channel 502 of said configurable wireless interface 501 for a plurality of receiving nodes 510 of said trajectory measurement system 250, and;
said data compression means 504 being arranged to provide rate-compressed trajectory 120 parameters or sensor outputs 301 of any of said sensors via a data exchange channel 503 of said configurable wireless interface 501 for a data exchange node 511 of said trajectory measurement system 250 upon query by said data exchange node 511.
21. The device 200 according to example 20, characterized in that, said device 200 being arranged to interact with a supervised computerized model 701 via said configurable wireless interface 501 for generating guiding principles 730 on the basis of the outputs generated by said data compression means 504.
22. A carrying case 344 for storing multiple recreational equipment 100 comprising a device 200 according any of the examples 19-21, characterized in that said carrying case 344 comprises:
   a plurality of counter interfaces 345 arranged to interact with the magnetic interfaces 341 of said multiple recreational equipment 100, arranged to charge the batteries of the devices 200 of said multiple recreational equipment 100 stored in said carrying case 344.
23. A method for characterizing flight properties of recreational equipment 100, characterized in:
   identifying at least one recreational equipment 100 as a first set of variables;
   collecting trajectory 120 parameters for a series 720 of activity cycles 400 related to each identified member 710 of said first set of variables via a configurable wireless interface 501 of a trajectory measurement system 250;
      wherein:
using a trajectory metering device 200 associated with each identified member 710 of said first set of variables for providing state information with related trajectory 120 parameters of said variables, derived from the sensor outputs 301 of said device 200 by said device 200;
via said configurable wireless interface 501 and from said device 200, receiving said state information by:
   receiving information of a detected flight period 403 having an ascending phase 403′, a leveling phase 403″, and descending phase 403″, associated at least with motional parameters of spatial velocity, spin, tilt angle, nose angle, and altitude, and;
   receiving information of a transition event 406 between an initiation period 402 and said flight period 403 detected by said device 200, and receiving said information associated at least with the departure vector 115 comprising departure angle and departure velocity, and other motional parameters at least of departure spin, departure tilt angle, and departure nose angle, and;
   receiving information of a rolling period 406 tailing said flight period 403, associated at least with geospatial location information and flight time of the associated recreational equipment 100; and
providing said trajectory 120 parameters and related state information to be used as a training set for a supervised computerized model 701, wherein said supervised computerized model 701 being adaptable to learn the non-linear dependencies between at least one of the motional parameters of the transition events 406 and at least one of the motional parameters of the flight periods 403 of said series of collected activity cycles 400 identifiable with each member 710 of said first set of variables;
   wherein:
from said series of collected activity cycles 400, providing a set of cycles 400 identifiable as labeled inputs 705 for said supervised computerized model 701, and providing said cycles 400 associable with a corresponding identified member 710 of said first set of variables, and
providing said cycles 400 identifiable as labeled inputs to be used by said supervised computerized model 701 to suggest guiding principles based on a new transition event 406 detected with a trajectory metering device 200 of an identifiable recreational equipment 100.
24. A device 200 for tracking a state of a recreational equipment 100, characterized in that,
   the device being a trajectory metering device 200 of said recreational equipment 100 comprising at least a gyroscope 302, and a magnetometer 303, and at least one of an accelerometer 304, a GNSS receiver 305, or a barometer 306, and;
   said device 200 comprising a digital radio transceiver 310 with a configurable waveform for exchanging data via a configurable wireless interface 501, and;
   said device 200 being adapted to track the state of said recreational equipment 100 during an activity cycle 400 of said equipment 100 with said device 200 comprising means to detect an initiated activity cycle 400 during a flight period 403, comprising at least means for detecting a rotational anomaly in the main rotational axis of
   said recreational equipment 100 by means of mapping two gyroscopic components of the two axes crossing the axis of said main rotational axis for the detection of said flight period 403, and;
   said device 200 being configured to share said state via said interface 501.
25. The device 200 according to example 24, characterized in that, said digital radio transceiver 310 being a Bluetooth Low Energy radio configurable to interact with at least a plurality of nodes 510 via a broadcast channel 502 and with a data exchange node 511 via a data exchange channel 503 of said interface 501.
26. The device 200 according to example 24 or 25, characterized in that, said device 200 being adapted to track the state changes of said recreational equipment 100 during said activity cycle 400 by being adapted to detect an initiation period 402 prior to said flight period 403 by means of a traceback search of an anomaly in an accelerometer 304 buffer within a time window 411 triggered by said rotational anomaly in the main rotational axis of said recreational equipment 100.
27. The device 200 according to example 24 or 25, characterized in that, said device 200 being adapted to track the state changes of said recreational equipment 100 during said activity cycle 400 by:
being adapted to detect an initiation period 402 prior to said flight period 403 by means of a traceback search of an anomaly in an accelerometer 304 buffer within a time window 411 triggered by said rotational anomaly in the main rotational axis of said recreational equipment 100, and;
being adapted to detect a transition event 406 between said initiation period 402 and said flight period 403 by detecting an anomaly in an accelerometer 304 output within said time window 411, and;
being adapted to assign a trajectory 120 state parameter derived from the accelerometer 304 output at said transition event 406 to be shared via said interface 501 as a parameter of said state.
28. The device 200 according to examples 24 or 25, characterized in that, said device 200 being adapted to track the state changes of said recreational equipment 100 during said activity cycle 400 by being adapted to separate an ascending phase 403′ from a leveling phase 403″ of said flight period 403 by means of detecting a suppression of at least one time-harmonic gyroscopic component from at least one of said two axes crossing the axis of said main rotational axis of said recreational equipment 100.
29. The device 200 according to example 28, characterized in that, said device 200 being adapted to track the state changes of said recreational equipment 100 during said activity cycle 400 by being adapted to separate a descending phase 403′″ from a leveling phase 403″ of said flight period 403 by means of an anomaly in a barometer 306 output of said device 200.
30. The device 200 according to examples 24 or 25, characterized in that, said device 200 being adapted to track the state changes of said recreational equipment 100 during said activity cycle 400 by:
   being adapted to detect an initiation period 402 prior to said flight period 403 by means of a traceback search of an anomaly in an accelerometer 304 buffer within a time window 411 triggered by said rotational anomaly in the main rotational axis of said recreational equipment 100, and;
   being adapted to detect a transition event 406 between said initiation period 402 and said flight period 403 by detecting an anomaly in an accelerometer 304 output within said time window 411, and;
   being adapted to assign a trajectory 120 state parameter derived from the accelerometer 304 output at said transition event 406 to be shared via said interface 501 as a parameter of said state, and;
   being adapted to separate an ascending phase 403′ from a leveling phase 403″ of said flight period 403 by means of detecting a suppression of at least one time-harmonic gyroscopic component from said two axes crossing the axis of said main rotational axis of said recreational equipment 100, and;
   being adapted to separate a descending phase 403″ from a leveling phase 403″ of said flight period 403 by means of an anomaly in a barometer 306 output of said device 200, wherein;
   said device 200 being adapted to share said state changes simultaneously to multiple receiving wireless receiving nodes 510 via a broadcast channel 502 of said interface 501.
31. A trajectory measurement system 250 for tracking a state of a recreational equipment 100, characterized in that,
   said system 250 comprising means to interact wirelessly with the device according to any of the examples 24 to 30 to receive the state information shared by said device 200 via said interface 501.
32. A trajectory measurement system 250 according to example 31, characterized in that,
   said system 250 comprising means to visualize the state of said device 200 by means of the trajectory 120 parameters shared via said interface 501.
33. A method for tracking the state of a recreational equipment 100, characterized in,
   using a device 200 according to any of the examples 24 to 30 for sharing the state information of said recreational equipment 100, and;
   using a system 250 according to example 32 to visualize said trajectory parameters using a mobile phone application.
34. A method for tracking the state of a recreational equipment 100, characterized in,
   using the parameter output of a device 200 according to any of the examples 24 to 30 for sharing the state information of said recreational equipment 100, and;
   using a system 250 according to example 32 to visualize said trajectory parameters using a digital television broadcast.
35. A method for tracking a state of a recreational equipment 100 during an activity cycle 400 of said equipment 100, characterized in:
   providing state information of a detected transition event 406 of a recreational equipment 100 during an activity cycle 400 of said equipment 100 with a trajectory metering device 200 of said recreational equipment 100;
   providing said state information combined with a motional parameter derived from an event of suppression of at least two time-harmonic components of at least three output components of a gyroscope 302 of said trajectory metering device 200.
36. A method for tracking a state of a recreational equipment 100 during an activity cycle 400 of said equipment 100, characterized in:
   providing state information of a detected transition event 406 of a recreational equipment 100 during an activity cycle 400 of said equipment 100, wherein;
   providing said state information derived from gyroscope 302 and accelerometer 304 based trajectory 120 parameters by a trajectory metering device 200 of said recreational equipment 100 by providing said state information by a detection of an anomaly of the accelerometer 304 output within a time window 411 of a buffer traceback search of said accelerometer 304 output triggered by an anomaly of a first 601 gyroscopic 302 component;
   providing said information via a broadcast channel 502 or a data exchange channel 503 of a configurable wireless interface 501 of a trajectory measurement system 250 to be shared with a receiving node 510 or a data exchange node 511 of said system 250;
   providing said state information available for at least one of said nodes 510,511 via at least one of said channels 502,503 with at least one motional parameter assigned to said transition event 406 by said device 200.
37. The method according to example 36, wherein, providing said state information derived from gyroscope 302 and accelerometer 304 based trajectory 120 parameters by a trajectory metering device 200 of said recreational equipment 100 by providing said state information by a detection of an anomaly of the accelerometer 304 output within a time window 411 of a buffer traceback search of said accelerometer 304 output triggered by an anomaly of a first 601 gyroscopic 302 component determined from the sinusoidal second 602 or third 603 gyroscopic 302 output components.
38. The method according to example 36, wherein, providing said state information derived from gyroscope 302 and accelerometer 304 based trajectory 120 parameters by a trajectory metering device 200 of said recreational equipment 100 by providing said state information by a detection of an anomaly of the accelerometer 304 output within a time window 411 of a buffer traceback search of said accelerometer 304 output triggered by the rotation speed of said recreational equipment 100 around a first axis exceeding a first rotational threshold 420 over a first threshold period 410.
39. The method according to example 36, wherein, providing said state information derived from gyroscope 302 and accelerometer 304 based trajectory 120 parameters by a trajectory metering device 200 of said recreational equipment 100 by providing said state information by a detection of an anomaly of the accelerometer 304 output within a time window 411 of a buffer traceback search of said accelerometer 304 output triggered by an ellipsoid of the combined output of two time-inharmonic components of the three gyroscope 302 outputs.
40. The method according to any of the examples 36-39, wherein, providing said state information with at least one motional parameter assigned to said transition event 406 by said device 200, combined with a motional parameter derived from an event of suppression of the time-harmonic outputs of at least two of the three output components of said gyroscope 302.
41. The method according to example 23, characterized in;
   providing said supervised computerized model 701 with wind inputs comprising at least of a direction and an intensity of wind associated with at least two of the activity cycles of said series 720 of activity cycles for said model to learn trajectorial anomalies caused by wind, wherein in providing said wind inputs, providing at least two non-uniform wind inputs associated with at least one identified member 710 of said first set of variables.
42. The method according to example 41, characterized in;
   providing said wind inputs to be associated with a trajectorial anomaly deviating from a statistical performance of said at least one identified member 710 of said first set of variables, by said supervised computerized model 701 from the basis of the learning process of said supervised computerized model 701.
43. A supervised computerized model 701 for adjusting the flight performance of a recreational equipment 100 associated with gaming activities, characterized in that,
   The supervised computerized model 701 being adapted to learn the non-linear dependencies between at least one motional parameter associated with the transition events 406 and at least one of motional parameter associated with the flight periods 403 in series 720 of collected activity cycles 400 of recreational equipment 100, and wherein said series 720 being identifiable with at least one member 710 of a first set of variables of said series 720,
   wherein, said supervised computerized model 701 being adapted to suggest guiding principles based on a new transition event 406, detected with a trajectory metering device 200 of a recreational equipment 100 identifiable with said at least one member 710, for adjusting the flight performance of said recreational equipment 100.
44. The supervised computerized model 701 according to example 43, characterized in that, said device 200 being the device 200 according to examples 19-21.
45. The supervised computerized model 701 according to example 43, characterized in that, said device 200 being the device 200 according to examples 24-30.
46. The supervised computerized model 701 according to any of the examples 43-45, characterized in that, said model being adapted to 701 to learn said non-linear dependencies from trajectory parameters measured according to the methods according to any of the examples 1-18.
47. The supervised computerized model 701 according to any of the examples 43-46, characterized in that, said supervised computerized model 701 being a form of artificial intelligence adapted to weight preferred trajectories in the learning process with labeled inputs provided by a gamer on the basis of measured flight paths.
48. The supervised computerized model 701 according to any of the examples 43-47, characterized in that, said supervised computerized model 701 being adapted to interact with a supervised computerized profile 702, wherein said profile being adapted to reflect the gamer-specific flight properties of a recreational equipment 100, associated with said at least one identifiable member 710.
49. The supervised computerized model 701 according to example 48, characterized in that, said supervised computerized model 701 being adapted to suggest guiding principles on said supervised computerized profile 702.
50. The supervised computerized model 701 according to examples 48 or 49, characterized in that, said supervised computerized model 701 being adapted to reflect the progress of said supervised computerized profile 702 on the basis of the suggested guiding principles on at least one of the motional parameters associated with said transition event 406.
51. The supervised computerized profile 702 according to any of the examples 48-50, characterized in that, said supervised computerized model 702 being an avatar that is adapted to reflect statistical parameters of a gamer profile, comprising at least two of a measured departure velocity, departure angle, departure tilt angle, departure nose angle, average altitude during the flight path, average distance of a flight path, and maximum distance of a flight path, associated with said at least one member 710 of said first set of variables.
52. A carrying case 344 for storing multiple recreational equipment 100 comprising a device 200 according any of the examples 19-21, characterized in that said carrying case 344 comprises:
   a plurality of counter interfaces 345 arranged to interact with the magnetic interfaces 341 of said multiple recreational equipment 100, arranged to charge the batteries of the devices 200 of said multiple recreational equipment 100 stored in said carrying case 344.
53. A carrying case 344 for storing multiple recreational equipment 100 comprising a device 200 according any of the examples 24-30, characterized in that said carrying case 344 comprises:
   a plurality of counter interfaces 345 arranged to interact with the magnetic interfaces 341 of said multiple recreational equipment 100, arranged to charge the batteries of the devices 200 of said multiple recreational equipment 100 stored in said carrying case 344.
54. A carrying case 344 according to examples 52 or 53, characterized in that said carrying case 344 being adapted to interact with a receiving node 510 via said configurable wireless interface 501 for providing information of at least of the number of recreational equipment within said case 344 or the battery status of the devices 200 being coupled with said counter interfaces 345.

In the following, the reference numerals used in this specification are listed:
100 recreational equipment
110 flight path
115 departure vector (explains all related physics at the moment when hand is released)
120 trajectory (digital representation of a measured flight path)
121 state parameters
200 trajectory metering device/device for trajectory metering
250 trajectory measurement system
301 sensor output (any sensor or a combination)
302 gyroscope
303 magnetometer
304 accelerometer
305 GNSS receiver
306 barometer
310 Digital radio transceiver (e.g. a low-energy Bluetooth™ device BLE)
311 memory
312 control unit
320 inertial measurement unit (IMU)
330 at least partially coiling resonant current
340 battery
341 magnetic interface
342 charging unit (of device 200)
343 charger unit (of the carrying case) with a power source
344 carrying case
345 counter interface
400 activity cycle (comprising a full movement of the equipment)
401 null: not being played
402 initiating period
403 flight period
403′ ascending phase
403″ leveling phase
403′″ descending phase
404 rolling period
405 end sequence
406 transition (event) between periods
410 threshold period
411 time window (to search for the event where the equipment leaves the hand)
420 rotational threshold
501 configurable wireless interface
502 broadcast channel
503 data exchange channel
504 data compression means
510 receiving node
511 data exchange node
600 gyroscopic coordinates
601 first gyroscopic component (Z)/outputs the main rotation axis during flight (not start of flight)
602 second gyroscopic component (X)
603 third gyroscopic component (Y)
605 main rotation axis
609 accelerometer coordinates
610 combined accelerometer output
611 first accelerometer coordinate output
612 second accelerometer coordinate output
613 third accelerometer coordinate output
650 diagonal length of the device 200
701 supervised computerized model/coach
702 variable-specific supervised computerized profile
705 labeled input
710 member of a first set of variables
720 series of activity cycles (during data collection)
721 series of gaming cycles (may be during a game, or just in a practice)
722 gamer
730 guiding principles

1. A method for trajectory tracking of a recreational equipment, comprising:
tracking sensor outputs of at least a gyroscope and an accelerometer of a trajectory metering device of the recreational equipment during an activity cycle, for forming a discretized trajectory of a flight path of said equipment;
by means of data compression within said trajectory metering device, transforming said sensor outputs into state parameters related to said trajectory, presenting at least an initiating period, a flight period, and a transition event between said two periods, and associating at least a motional parameter with at least one of said state parameters and sharing said state parameters via a configurable wireless interface for at least partial reconstruction of said trajectory
wherein, prior to said activity cycle, signaling an initiating flag to activate spatial mapping of said device by detecting motional anomalies of said device during a null period of said trajectory metering device, and preparing to detect activity events of said activity cycle;
wherein, during said activity cycle detecting said activity cycle said data compression means by:
detecting an initiating period of said trajectory during which the momentum of said equipment being increased by an external force applied to said equipment, and
detecting a flight period of said trajectory during which the momentum of said equipment being decreased in the absence of said force;
wherein, in detecting said periods:
first detecting said flight period from the outputs of said gyroscope by detecting a first gyroscopic component exceeding a first rotational threshold over a first threshold period, after which;
detecting said initiating period by detecting the transition between said two periods from a null or a local minimum of one of the coordinate components of said tracked accelerometer outputs using a time window exceeding said first threshold period backwards in time after said first gyroscopic component exceeds said first rotational threshold over said first threshold period.

2. The method according to claim 1, wherein, by means of data compression within said device, using a windowed moving average on at least one of said sensor outputs in generation of said trajectory to be shared via said interface at a compressed rate.

3. The method according to claim 1, wherein, by means of data compression within said device, using suppressed sample rate on at least one of said sensor outputs in generation of said trajectory to be shared via said interface at a compressed rate.

4. The method according to claim 1, wherein, in forming said discretized trajectory, using a non-uniform sampling ratio during said activity cycle by using a sampling ratio of at least 2:1 between two activity phases.

5. The method according to claim 1, wherein, in detecting said first gyroscopic component, prior to detecting said first gyroscopic component, using a projection from a second or a third gyroscopic component for generation of said first gyroscopic component to be detected.

6. The method according to claim 1, wherein, in detecting said first gyroscopic component, prior to detecting said first gyroscopic component, using a root of a time-inharmonic cyclometric function for projecting a second or a third gyroscopic component as said first gyroscopic component to be detected.

7. The method according to claim 1, wherein, tracking the sensor outputs of at least said gyroscope and said accelerometer using an inertial measurement unit of said device.

8. The method according to claim 1, wherein, in detecting said periods, said first threshold period being between 1 ms and 5000 ms.

9. The method according to claim 1, wherein, in detecting said flight period using a rotational threshold between 1 and 50 RPS.

10. The method according to claim 1, wherein,
after signaling said initiation flag, tracking the outputs of said accelerometer, and;
after detecting said transition event, associating the spatial velocity derived from said accelerometer outputs with said transition event, and;
sharing said state parameters via said configurable wireless interface for at least partial reconstruction of said trajectory.

11. The method according to claim 1, wherein, using a buffer traceback search triggered by the detection of said transition event for associating said transition event with the related momentary motional parameters of at least spatial velocity, launch angle, spin, and tilt, and sharing said state related motional parameters via said configurable wireless interface to be visualized by a trajectory measurement system.

12. The method according to claim 1, wherein, in sharing said state parameters via the configurable wireless interface, using an antenna with an average gain below +5 dBi and with the diagonal length of the device delimited below a quarter of a wavelength at the frequency of operation of said wireless interface and with a resonant current at least partially coiling in a plane that is crossing the main rotation axis of the equipment upon use of the wireless interface by said device.

13. The method according to claim 1, wherein, during said flight period,
distinguishing an ascending phase from a leveling phase, of said equipment by said device by combined data from the gyroscope and an accelerometer.

14. The method according to claim 13, wherein, during said activity cycle,
distinguishing an ascending phase from said leveling phase, of said equipment by said device by
receiving information of a detected flight period having an ascending phase a leveling phase, and descending phase, associated at least with motional parameters of spatial velocity, spin, tilt angle, nose angle, and altitude;
detecting an initiating period of said trajectory during which the momentum of said equipment being increased by an external force applied to said equipment, and
detecting a flight period of said trajectory during which the momentum of said equipment being decreased in the absence of said force;
wherein, in detecting said periods data from the gyroscope and an accelerometer are used.

15. The method according to claim 1, wherein, determining a start event of a rolling period that follows said flight period by detecting the main rotation axis being tilted by detecting said first gyroscopic component falling below said first rotational threshold, and detecting the start of an end sequence by detecting the moving average of at least three samples of the flight path,
and;
using the duration of said flight period for the determination of the flight time of said recreational equipment, and the duration of said rolling period on the basis of said start of said end sequence.

16. The method according to claim 15, wherein the three samples are obtained from an output of a GNSS receiver being stabilized inside a radius less than 1.5 meters.

17. The method according to claim 1, wherein, using said discretized trajectory for teaching a supervised computerized model to learn the non-linear relationships between at least two parameters associated with dynamics of said recreational equipment tracked by said device during said initiation period and dynamics of said recreational equipment tracked by said device during said flight period.

18. The method according to claim 1, wherein, using a supervised computerized model for learning the non-linear relationships between at least two parameters associated with the dynamics of said recreational equipment tracked by said device during said initiation period and the dynamics of said recreational equipment tracked by said device during a series of activity cycles associated with said recreational equipment, and reflecting said relationships on a variable-specific supervised computerized profile taught to mimic the dynamics of a gamer operating said recreational equipment from a series of gaming cycles for generating guiding principles for adjusting the dynamics of said gamer during an initiation period.

19. The method according to claim 18, wherein, providing said supervised computerized model with wind inputs comprising at least of a direction and an intensity of wind associated with at least two of the activity cycles of said series of activity cycles for said model to learn trajectorial anomalies caused by wind, wherein in providing said wind inputs, providing at least two non-uniform wind inputs associated with a common variable.

20. The method according to claim 1 comprising using various sleep modes to inactivate a sensor when not in use.

21. A trajectory measurement device of a recreational equipment for performing the activities according to claim 1, wherein, said device comprises:
a battery,
a magnetic interface arranged for wirelessly charging said battery via a charging unit,
an antenna arranged to connect said device with members of a trajectory measurement system via a configurable wireless interface operable via said antenna and by a resonant current at least partially coiling in a plane that is crossing the main rotation axis of the equipment upon use of the wireless interface by said device and wherein the diagonal length of the device being delimited below a quarter of a wavelength at the frequency of operation of said wireless interface:
sensors providing sensor outputs, said sensors comprising at least:
magnetometer
inertial measurement unit comprising at least a gyroscope and an accelerometer,
barometer,
GNSS receiver, and;
data compression means arranged to transform the sensor outputs of at least two of the sensors of said device into a state parameter of the recreational equipment related to said device with an associated motional parameter.

22. The trajectory measurement device according to claim 21, comprising,
said device (200) being arranged to provide said state parameters and the associated motional parameters via a broadcast channel-(502) of said configurable wireless interface for a plurality of receiving nodes of said trajectory measurement system, and; said data compression means being arranged to provide rate-compressed trajectory parameters or sensor outputs of any of said sensors via a data exchange channel of said configurable wireless interface for a data exchange node of said trajectory measurement system upon query by said data exchange node.

23. The trajectory measurement device according to claim 22, wherein, said device being arranged to interact with a supervised computerized model via said configurable wireless interface for generating guiding principles on the basis of the outputs generated by said data compression means.

24. The trajectory measurement device according to claim 21, wherein the device is configured to use various sleep modes to inactivate a sensor when not in use.

25. (canceled)
